(19) United States
(12) Patent Application Publication
(10) Pub. No.: US 2016/0364011 A1
(43) Pub. Date: Dec. 15, 2016

(54) HUMAN MACHINE INTERFACE CONTROLLER

(71) Applicant: Microsoft Technology Licensing, LLC., Redmond, WA (US)

(72) Inventor: David Bohn, Fort Collins, CO (US)

(21) Appl. No.: 14/739,624

(22) Filed: Jun. 15, 2015

(51) Int. Cl. G06F 3/033; A63F 13/825; G09G 3/00; A63F 13/23; H04M 1/725; H04N 9/31

(52) U.S. Cl. CPC G06F 3/033; H04M 1/72544; H04N 9/3141; G09G 3/002; A63F 13/23; A63F 13/825; G09G 2320/06; G09G 2360/10

(57) ABSTRACT

A handheld controller for controlling a computer video game that receives streaming video data defining images of regions of a virtual game environment that the computer transmits; projects the images defined by the video data along a projection axis to form the images on a surface that the projection axis intersects so that a user may view and interact with the images; transmits position and/or orientation (P/O) data that defines positions and/or orientations of the projection axis to control for which regions of the virtual environment the computer streams video; and comprises an actuator operable to disengage the P/O data so that video data received from the computer does not change responsive to changes in position and/or orientation of the controller.

### BACKGROUND

Various systems for interfacing a person with a computer or a machine (hereinafter, generically referred to as a computer) are known, and are typically referred to under the rubric “human machine interface” (HMI). HMI systems typically include at least one user controller that a user may operate to input information to the computer, and at least one computer output device that the computer operates to respond to user input and provide feedback and information to the user. The at least one user controller may include, by way of example, at least one, or any combination of more than one of the familiar keyboard, mouse, joystick, microphone, gesture recognition system, video game controller, and/or robotics controller. Video game and robotics controllers are typically multiple actuator controllers which may be outfitted with at least one, or a combination of more than one of a host of different actuators, such as by way of example, various buttons, sliders, toggle switches, analog sticks, triggers, and steering wheels. The at least one computer output device almost invariably comprises at least one visual output device, typically a computer screen, and generally includes a speaker for audio feedback. An HMI computer output device may also include devices other than visual and audio devices and may for example comprise a tactile feedback device and/or a device that stimulates the olfactory senses.

### SUMMARY

An aspect of an embodiment of the disclosure relates to providing a handheld HMI controller operable by a user to input user information into a computer and to receive image data from the computer that defines images of regions of an environment that the computer generates in response to user input information. The HMI controller, hereinafter also referred to as a “handy controller”, is configured to use the image data that it receives from the computer to project images that the image data defines so that the user may view and interact with the images. The handy controller projects the images along a projection axis of the handy controller and the user views the images on surfaces that the projection axis intersects. To indicate to the computer for which regions of the computer environment to transmit image data to the handy controller for projection, the handy controller generates and provides the computer with position and/or orientation data that respectively define the spatial position and/or orientation of the handy controller. The computer may use the data, hereinafter also referred to as “P/O data”, to generate and transmit to the handy controller, image data that defines images of regions, hereinafter also referred to as “target regions”, of the computer environment that correspond to the position and/or orientation of the handy controller. The handy controller includes an actuator, hereinafter also referred to as an “image clutch”, which the user may operate to “disengage” the P/O data so that the user may change the position and/or orientation of the handy controller without receiving image data from the computer that changes a target region.

Generating images responsive to the P/O data enables the user to use the handy controller to move around the computer environment and see and interact with different desired target regions of the environment by changing the position and/or orientation of the handy controller. Using the image clutch to disengage the P/O data enables the user move the handy controller around so that it projects images onto a surface for which it is convenient to view the images without changing a target region that the handy controller projects.

A handy controller in accordance with an embodiment of the disclosure may be used to interact with any of various different types of environments that the computer may generate. For example, the handy controller may be used to interact with a work environment generated by a computer or with a virtual interactive game environment that the computer generates.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF FIGURES

Non-limiting examples of embodiments of the disclosure are described below with reference to figures attached hereto that are listed following this paragraph. Identical features that appear in more than one figure are generally labeled with a same label in all the figures in which they appear. A label labeling an icon representing a given feature of an embodiment of the disclosure in a figure may be used to reference the given feature. Dimensions of features shown in the figures are chosen for convenience and clarity of presentation and are not necessarily shown to scale.

FIG. 1 schematically shows a handy controller being used to play a video game and rotated to change a target region in the video game virtual environment generated by a server, in accordance with an embodiment of the disclosure;

FIG. 2 schematically shows an enlarged image of a handy controller similar to that shown in FIG. 1 and components of the handy controller that support functionalities that the handy controller provides, in accordance with an embodiment of the disclosure;

FIG. 3 shows a calibration pattern that may be used to calibrate a handy controller to a computer generated environment in accordance with an embodiment of the disclosure; and

FIG. 4 shows a mobile computing device that is mounted to a cradle to provide a handy controller, in accordance with an embodiment of the disclosure.

### DETAILED DESCRIPTION

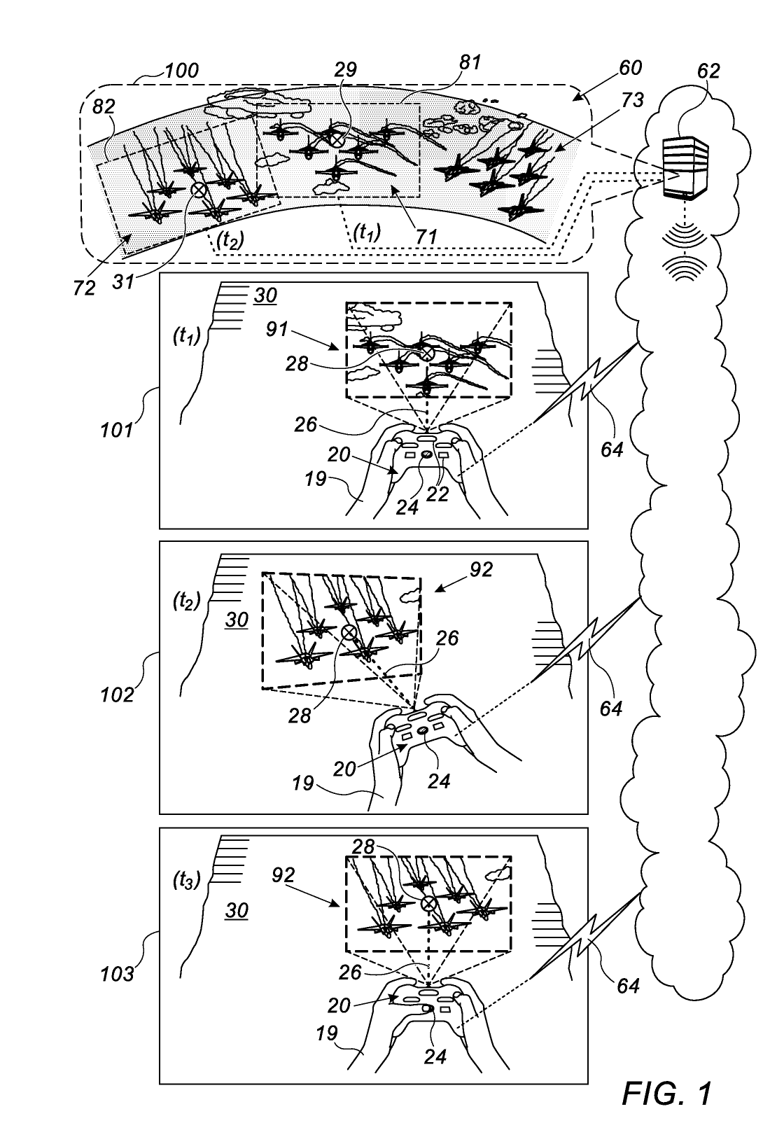

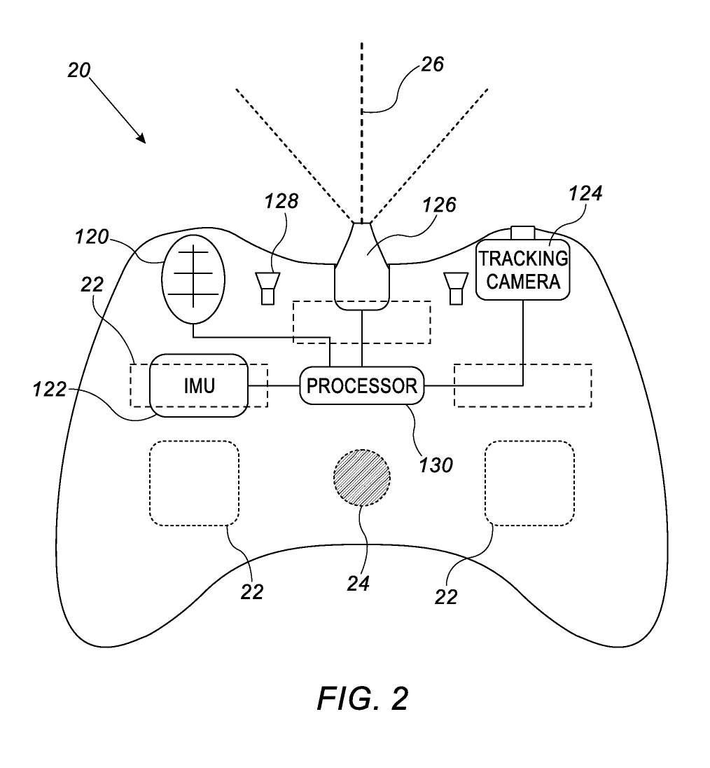

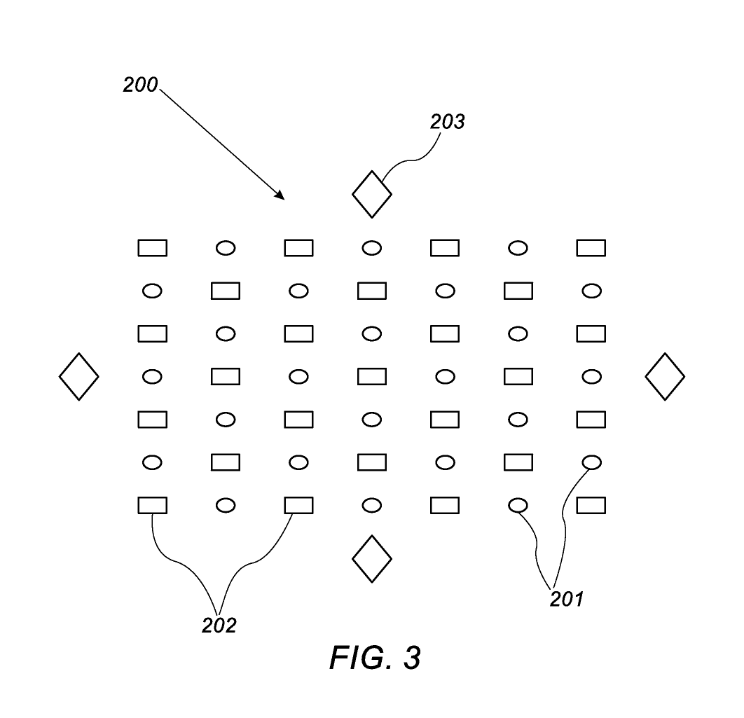

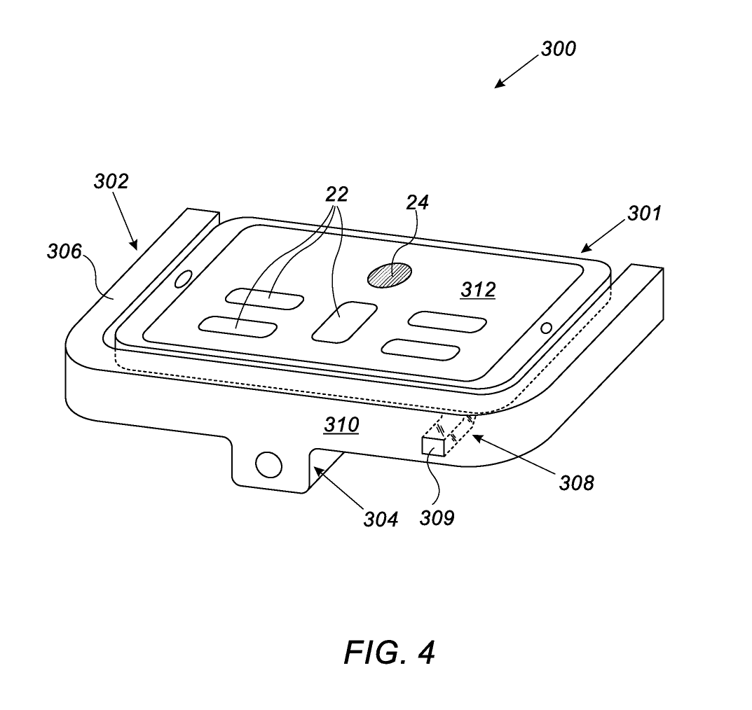

In the description below, operation of a handy controller having an image clutch in accordance with an embodiment of the disclosure is schematically shown in FIG. 1 and discussed with reference to the figure. In FIG. 1 a user is schematically shown using the handy controller to interact with, by way of example, a computer game virtual environment generated and streamed to the handy controller by a server with which the handy controller communicates. The handy controller is schematically shown at a first time during the user's interaction with the game, projecting in a first projection direction images of a first target region of the virtual environment for which the server streams image data to the handy controller. Hereinafter, providing or streaming image data that define images of a computer generated environment, or portion thereof may also be referred to as providing or streaming the images. The handy controller is schematically shown at a subsequent, second time with the image clutch engaged to engage P/O data provided by the handy controller with the server. At the second time, the user is shown rotating the handy controller to access, and project along a second projection direction, images of a second target region of the computer environment that the streamer streams to the handy controller for user interaction. At a third, later time, the user is shown operating the image clutch to disengage P/O data so the user may reorient the handy controller without changing the target region to project images of the second target region onto a surface that the user finds preferable for viewing. FIG. 2 schematically shows an enlarged image of the controller shown in FIG. 1 that shows components of the handy controller which support functionalities provided by the handy controller. FIG. 3 shows a possible calibration pattern that may be projected by a handy controller to calibrate the handy controller to a computer environment that the handy controller interfaces with a user. FIG. 4 schematically shows a smartphone that is mounted to a cradle comprising a projector so that the combination of the smartphone and cradle provide a handy controller in accordance with an embodiment of the disclosure.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended. Unless otherwise indicated explicitly or by context, the word “or” in the description and claims is considered to be the inclusive “or” rather than the exclusive or, and indicates at least one of, or any combination of items it conjoins.

FIG. 1 schematically shows a user 19, only whose hands are shown in the figure, using a handy controller 20 to interact with a computer environment 60 shown in an inset 100, optionally generated and streamed to the handy controller by, optionally, a cloud based server 62 with which the handy controller communicates. Optionally, handy controller 20 communicates with server 62 via a wireless communication channel, such as a WiFi or Bluetooth channel, indicated by “communication lightning bolts” 64. By way of example, in FIG. 1 server 62, and user 19 operating handy controller 20, are engaged in a shoot′em up game session and computer environment 60 is a virtual combat environment in which the user is in combat with a multitude of attacking fighter aircraft that the server has generated for the game. Virtual combat environment 60 is, optionally, configured as a “panoramic configuration” of three groups, 71, 72, and 73 of attacking fighter squadrons.

For interacting with computer environment 60, handy controller 20 comprises a projector (shown in FIG. 2) for projecting onto surfaces for user viewing, images of regions of computer environment 60 that server 62 streams to handy controller 20. The handy controller comprises any combination of one, or more than one, of various control buttons, sticks, triggers, and sliders, referred to generically as control buttons 22, for interacting with the projected images of target region, and an image clutch 24 in accordance with an embodiment of the disclosure.

During the game session, handy controller 20 repeatedly updates and transmits P/O data, defining the position and/or orientation of the handy controller to server 62. In response, server 62 streams to handy controller 20 images of portions, “target regions” of computer environment 60 corresponding to the P/O data for projection by the handy controller so that the user may view and interact with the target regions by operating the various control buttons 22 comprised in the handy controller. The user is able to select different target regions of computer environment 60 to view and interact with by changing the orientation and/or position of handy controller 20 to send different P/O data to server 62. Handy controller 20 projects images it receives from server 62 along a projection axis indicated by a bold dashed line 26.

At a time t₁ during play of the shoot-em-up game schematically shown in an inset 101, also labeled with time t₁ in parenthesis, user 19 orients handy controller 20 substantially parallel to the floor and in a direction that points projection axis 26 so that it is substantially perpendicular to a wall 30. An intersection region of projection axis 26 with wall 30 is marked by a crosshair 28, optionally projected by the handy controller. Substantially at time t₁, handy controller 20 transmits to server 62 via communication channel 64 P/O data that defines position and/or orientation of the handy controller at time t₁. The server processes the P/O data to determine a target region of computer environment 60 that corresponds to the position and orientation of handy controller 20 defined by the P/O data and streams image data to handy controller 20 that enables the handy controller to project an image of the target region.

By way of example, server 62 determines that the P/O data received from handy controller 20 at time t₁ indicates that position and orientation of handy controller 20 corresponds to a target region of computer environment 60 bounded by a dashed rectangle 81 and containing attacking fighter squadron 71, and optionally that crosshair 28 corresponds to a corresponding virtual crosshair 29 in the combat environment. As a result, server 62 streams image data to handy controller 20 that causes the handy controller, as schematically shown in inset 101, to project images, represented by image 91, of target region 81 for user 19 to interact with on wall 30. The image data also optionally comprises image data that causes handy controller 20 to project crosshair 28, which marks the intersection of projection axis 26 with wall 30. User 19 may use the location of crosshair 28 to indicate where her handy controller 20 is pointing to in computer environment 60 and when, for example, to press a trigger button (not distinguished from other control buttons 22) among control buttons 22 comprised in handy controller 20 to launch antiaircraft missiles (not shown) in an attempt to shoot down an incoming fighter in attacking fighter squadron 71.

At a time t₂ subsequent to time t₁ user 19 rotates handy controller 20 to the left of target region 81, to determine if a threat from the left is imminent and has to be dealt with, as schematically shown in an inset 102 labeled with time t₂ in parenthesis. In response, substantially at time t₂, handy controller 20 transmits P/O data to server 62 that indicates that the handy controller has been rotated to the left. Server 62 processes and determines responsive to the P/O data that the position and orientation of handy controller at time t₂ corresponds to a target region of computer environment 60 outlined by a dashed rectangle 82 containing attacking fighter squadron 72 and a virtual cross hair 31 corresponding to crosshair 28 shown in inset 102. The server streams image data to handy controller 20 that the handy controller uses to project images, represented by an image 92 of target region 82 onto wall 30 for interaction with user 19.

However, because image 92 is projected at an angle off normal onto wall 30, the projected image has a degree of image distortion that user 19 finds uncomfortable. Therefore, at a time t₃, as shown in inset 103, also labeled with time t₃ in parentheses, user 19 operates image clutch 24 to disengage P/O data generated by handy controller 20 from server 62. With P/O data disengaged, server 62 does not change target regions in computer environment 60 for which it streams image data to handy controller 20 with changes in position and/or orientation of handy controller 20. As a result, user 19 is able to redirect handy controller 20 by rotating the handy controller to the right so that it projects images it receives from server 62 substantially perpendicular to wall 30 without the server replacing target region 82 with another target region from computer environment 60. Inset 103 shows handy controller 20 after the user has rotated the handy controller so that the handy controller is in substantially the same position and orientation as it was in inset 101 but projecting images of target region 82 perpendicular to wall 30 instead of reverted to project images of target region 81 onto the wall 30 as shown in inset 101. With images 92 of target region 82 projected substantially perpendicular to wall 30, user 19 is able to view and interact with features of target region 82 without the distortion that user 19 found disturbing when the images were projected off normal to the wall.

After reorienting handy controller 20 to project image 92 of target region 82 perpendicular to wall 30, user may operate image clutch 24 to engage P/O data with server 62 so that the user may move around and interact with different target regions of computer environment 60 by changing position and/or orientation of handy controller 20.

In an embodiment image clutch 24 may, by way of example, be a button which may be depressed to engage and disengage P/O data. For example, if P/O data generated by handy controller 20 is engaged, image clutch 24 may be depressed to disengage the P/O data, and if disengaged, the mage clutch may be depressed to engage the P/O data. When engaged, P/O data is repeatedly updated and transmitted to server 62. Optionally the P/O data is updated and optionally transmitted to provide server 62 with substantially real time P/O data at a rate substantially equal to or greater than a frame rate at which server 62 streams images to handy controller 20. When disengaged, optionally, handy controller 20 does not update P/O data responsive to changes in position and/or orientation of the handy controller. Whereas, when disengaged, handy controller 20 may not update the P/O data, optionally the handy controller transmits the, non-updated, P/O data to the server at substantially a same rate at which it transmits P/O data when the P/O data is engaged.

FIG. 2 schematically shows components comprised in handy controller 20 that support functionalities provided by the handy controller, in accordance with an embodiment of the disclosure. In an embodiment, handy controller 20 may comprise an optionally wireless communications interface 120, an inertial measurement unit (IMU) 122, a motion tracking camera 124, a projector 126, and at least one speaker 128. A processor 130 receives communication signals received by communications interface 120, signals generated by IMU 122, and motion tracking camera 124, and signals generated by user operation of control buttons 22 (shown in dashed lines) and image clutch 24. The processor processes the signals to support functionalities provided by handy controller 20. Processor 130 may comprise any processing and/or control circuitry known in the art and may by way of example comprise any one or any combination of more than one of a microprocessor, an application specific circuit (ASIC), field programmable array (FPGA) and/or system on a chip (SOC). And whereas in FIG. 2 the processor is schematically shown as a single unit, processor 130 may be a distributed processor comprising a plurality of processors that cooperate to support the functionalities of the handy controller 20 and of which plurality at least two are housed in different components of the handy controller.

Wireless communications interface 120 may comprise any suitable transceiver and associated circuitry and software that are configured to establish and maintain wireless communication between handy controller and server 62 via communications channels 64 (FIG. 1). The wireless communications interface may for example include at least one or any combination of two or more radio communications interfaces such as for example, a mobile phone interface, a Bluetooth interface, and/or Wifi interface. Projector 126 may be any projector suitable for integrating into a hand held, game controller. An example of a projector that may be suitable for integration into handy controller 20 is a projector similar to high definition, 1920 pixel by 1080 pixel HD5 Laser Projection Engine marketed by Compound Photonics. The projector provides 50 lumens of luminous flux and has a volume footprint of about 4 cubic centimeters (cm³).

IMU 122 comprises a configuration of optionally micro-electro-mechanical systems (MEMS) that operate as accelerometers and gyroscopes to provide measurements of displacement and rotation of handy controller 20 that may be used to generate P/O data for transmission to server 62. In an embodiment, IMU 122 provides measurements responsive to displacement of handy controller 20 along optionally three orthogonal displacement axes (not shown), and measurements responsive to rotation of the handy controller about, optionally three orthogonal rotation axes (not shown). Optionally, IMU transmits the measurements to processor 130 for processing to determine “dead reckoning” position and/or orientation of handy controller 20. In an embodiment, IMU 122 comprises a processor that determines dead reckoning position and/or orientation of handy controller 20 based on measurements the IMU acquires, and transmits the dead reckoning position and/or orientation to processor 130. Dead reckoning position and/or orientation are subject to drift error over time, and in accordance with an embodiment of the disclosure, handy controller 20 calibrates or fuses, dead reckoning position and/or orientation with measurements provided by images acquired by motion tracking camera 124 to correct for drift and provide P/O data for transmission to server 62.

In an embodiment, motion tracking camera 124 acquires images of a real physical environment in which user 19 is using handy controller 20 and transmits the images to processor 130 for processing to provide measures responsive to motion of handy controller 20. Optionally, motion tracking camera 124 provides grayscale images of the user's environment. In an embodiment motion tracking camera provides color images of the environment. Optionally motion tracking camera 124 provides range images of the environment. Processor 130 processes the images to provide measures of changes in position and/or orientation of handy controller 20 resulting from user 19 moving the handy controller. Optionally, processor 130 processes the images to determine optical flow exhibited by the images resulting from user 19 moving handy controller 20, to provide measures of changes in position and/or orientation of handy controller. Processor 130 uses the measures of changes in position and/or orientation in accordance with any of various known algorithms to correct dead reckoning determinations of position and/or orientation based on data provided by IMU 122 for drift. In an embodiment, processor 130 provides the drift corrected position and/or orientation of handy controller 20 as P/O data for transmission by wireless communications interface 120 to server 62.

Responsive to the P/O data that handy controller 20 transmits to server 62 processor 130 receives from wireless communications interface 120 streaming video and optionally audio that server 62 transmits to the handy controller. The processor controls projector 126 to project the streamed video, and optionally, the at least one speaker to sound the streamed audio.

In an embodiment of the disclosure to provide corrected P/O data that may be used to navigate to, and view, different target regions of computer environment 60 prior to beginning play of the shoot-em-up game, handy controller 20 may be calibrated to computer environment 60. Optionally, to calibrate handy controller 20 to the shoot-em-up game, handy controller 20 may be moved by user 19 to scan a cross hair projected by the handy controller across a calibration pattern of fiducials that server 62 transmits to the handy controller for projection optionally onto wall 30. Each of the fiducials in the calibration pattern may be associated with different virtual coordinates of points in computer environment 60. The fiducials and fiducial pattern are advantageously configured so that they may relatively easily be used to determine optical flow generated by motion of the handy controller during the calibration scan from images of the fiducial pattern acquired by the motion tracking camera 124. P/O data generated by handy controller 20 and transmitted to server 62 during the calibration scan, and the known associations of the fiducials with virtual coordinates in the computer environment may be used to calibrate the handy controller to the computer environment.

For example, FIG. 3 shows a calibration pattern 200 comprising circular fiducials 201, rectangular fiducials 202 and diamond shaped fiducials 203 that may be used to calibrate handy controller 20 to computer environment 60. Diamond shaped fiducials 203 may be associated with points on the perimeter of rectangle 81 shown in FIG. 1 defining target region 81. For the calibration scan, server 62 may instruct user 19 to scan calibration pattern 200 by moving handy controller 20 to substantially center a cross hair (not shown in FIG. 3) projected by the handy controller indicating where projection axis 26 intersects a projection of calibration pattern 200 in turn on each of diamond fiducials 203. IMU data acquired by IMU 122 during motion of handy controller 20 may be processed by processor 130 to determine dead reckoning positions and/or orientations of the handy controller during the scan. Images of fiducials 201, 202, and 203 in images of calibration pattern 200 acquired by motion tracking camera 124 during motion of handy controller 20 may be processed by processor 130 to determine optic flow during the scan. The dead reckoning positions and/or orientations of handy controller 20 during the calibration scan may be fused with the optical flow to provide P/O “calibration” data. The P/O calibration data and the known associations of fiducials 201, 202, and 203 in calibration pattern 200 with virtual points in computer environment 60 may be used to calibrate handy controller 20 to the computer combat environment. For example, the P/O calibration data and associations of the fiducials with virtual points in computer environment 60 may be used to determine a magnitude of linear or angular virtual displacement in computer environment 60 that corresponds to a given magnitude of linear or angular displacement of handy controller 20.

It is noted that whereas FIG. 2 schematically shows a handy controller as an integral unit configured as a computer game controller, a handy controller in accordance with an embodiment of the disclosure may comprise a mobile computing device, such as a smartphone mounted to a cradle comprising a projector in communication with the smartphone. A suitable “handy app” downloaded to the smartphone may be used to configure the smartphone with a set of executable instructions to process data provided by an IMU and/or a camera in the smartphone to generate P/O data. A prism and/or optic fibers comprised in the cradle may be used to collect light from a physical environment in which a user may be using the smartphone for a handy controller to the smartphone camera to facilitate the camera acquiring images of the environment suitable for, optionally, providing measures of optic flow. The smartphone may transmit the P/O data to a computer interfaced with the handy controller via any communications channels that the smartphone supports, and receive streaming video and/or audio data from the computer via the channels. The smartphone may control the projector by transmitting suitable data and control signals to the projector via a wire or wireless channel provided by the cradle. Optionally, the channel is a wire channel connected to the power/data socket of the smartphone. Control buttons and an image clutch for operation by the user may be generated and presented on the smartphone touch screen by the app.

By way of example FIG. 4 schematically shows a mobile computing device in the form of a smartphone 301 mounted to a cradle 302 to provide a handy controller 300 in accordance with an embodiment of the disclosure. Cradle 302 comprises a projector 304 controllable by smartphone 301 to project images that are transmitted to the smartphone by, for example a server, which may be cloud based, or another smartphone. Smartphone 301 controls projector 304 by transmitting signals to the projector via a suitable wireless or wire channel supported by the cradle and/or the projector. The wireless channel may by way of example comprise a Bluetooth channel. The wire channel may by way of example comprise a cable (not shown) in cradle 302 that is connected between the projector and a plug (not shown) located in a wall 306 of the cradle that is configured to plug into the power/data socket of smartphone 301. Optionally, a prism 308 comprised in cradle 302 and having an aperture 309 on a wall 310 is optically coupled to a camera (not shown) in smartphone 301. Prism 308 collects light from a scene in front of aperture 309 and conducts the light to the smartphone camera so that the camera may acquire an image of the scene. The handy app downloaded to the smartphone generates control buttons 22 and an image clutch 24 on a touch screen 312 of smartphone 301 operable to interface the handy controller to a computer.

There is therefore provided in accordance with an embodiment of the disclosure a handheld controller for interfacing a user with a computer, the controller comprising: a projector; apparatus configured to generate measurements responsive to changes in position and/or orientation of the controller that are useable to generate position and/or orientation (P/O) data that define position and/or orientation of the controller respectively, which P/O data is usable by a computer to determine image data that the computer transmits to the controller; a processor operable to process the measurements to generate the P/O data, transmit the P/O data to the computer, and to control the projector responsive to the image data; and an actuator operable to disengage the P/O data so that image data received from the computer does not change responsive to changes in position and/or orientation of the controller.

Optionally, the apparatus configured to generate the measurements comprises an inertial measurement unit (IMU). Optionally, the processor is operable to receive the measurements provided by the IMU and to generate dead reckoning positions and/or orientations of the handheld controller which are used to provide the P/O data.

In an embodiment the handheld controller comprises a camera operable to acquire images of a physical environment in which the user uses the handheld controller. Optionally, the processor is operable to receive images acquired by the camera and to process the images to determine measures of changes in position and/or orientation of the handheld controller. Optionally, the processor is operable to process the images to determine optic flow evidenced by the images. In an embodiment the processor is operable to use the determined optic flow to correct the dead reckoning positions and/or orientations for drift.

In an embodiment the processor repeatedly updates and transmits the P/O data to the computer. Optionally when the actuator is operated to disengage the P/O data, the processor does not update the P/O data. Optionally, as long as the P/O data is disengaged, the processor repeatedly transmits to the computer P/O data that was last updated prior to disengagement of the P/O data. Optionally, as long as the P/O data is disengaged, the processor abstains from transmitting P/O data to the computer. In an embodiment the actuator is operable to engage the P/O data if the P/O data is disengaged.

In an embodiment the handheld controller is operable to interface a user with a virtual environment of a computer game.

In an embodiment the apparatus configured to generate the measurements and the processor are comprised in a smartphone mounted to a cradle comprising the projector.

There is further provided in accordance with an embodiment of the disclosure a method of interfacing a user with a computer generated environment, the method comprising: receiving streaming video data that defines video images of a computer environment generated by a computer; projecting images defined by the video data in a direction of a projection axis to form the images on a surface that the projection axis intersects so that a user may view and interact with the images; transmitting P/O data that defines position and/or orientation of the projection axis substantially in real time to control regions of the computer environment for which the computer streams video data for projection; and pausing updating the P/O data to enable the direction of the projection axis to be changed without changing a region for which the streaming video is received.

Transmitting P/O data optionally comprises acquiring data provided by an inertial measurement unit (IMU) and processing the IMU data to determine dead reckoning positions and/or orientations of the projection axis. Optionally, transmitting P/O data comprises acquiring images of scenes in a real physical environment of the projection axis and: processing data in the images to determine optic flow generated by movement of the projection axis; using the optic flow to correct the dead reckoning position and/or controlling for drift.

In an embodiment, subsequent to pausing, the method may comprise transmitting P/O data that was last updated prior to pausing to the computer.

In an embodiment, subsequent to pausing, the method may use a smartphone to provide and transmit the P/O data and receive the streaming video data.

In an embodiment the computer environment comprises a video game virtual environment.

In the description and claims of the present application, each of the verbs, “comprise” “include” and “have”, and conjugates thereof, are used to indicate that the object or objects of the verb are not necessarily a complete listing of components, elements or parts of the subject or subjects of the verb.

Descriptions of embodiments of the disclosure in the present application are provided by way of example and are not intended to limit the scope of the disclosure. The described embodiments comprise different features, not all of which are required in all embodiments. Some embodiments utilize only some of the features or possible combinations of the features. Variations of embodiments of the disclosure that are described, and embodiments comprising different combinations of features noted in the described embodiments, will occur to persons of the art. The scope of the invention is limited only by the claims.

1. A handheld controller for interfacing a user with a computer, the controller comprising:
a projector;
apparatus configured to generate measurements responsive to changes in position and/or orientation of the controller that are useable to generate position and/or orientation (P/O) data that define position and/or orientation of the controller respectively, which P/O data is usable by a computer to determine image data that the computer transmits to the controller;
a processor operable to process the measurements to generate the P/O data, transmit the P/O data to the computer, and to control the projector responsive to the image data; and
an actuator operable to disengage the P/O data so that image data received from the computer does not change responsive to changes in position and/or orientation of the controller.

2. The handheld controller according to claim 1 wherein the apparatus configured to generate the measurements comprises an inertial measurement unit (IMU).

3. The handheld controller according to claim 2 wherein the processor is operable to receive the measurements provided by the IMU and to generate dead reckoning positions and/or orientations of the handheld controller which are used to provide the P/O data.

4. The handheld controller according to claim 3 and comprising a camera operable to acquire images of a physical environment in which the user uses the handheld controller.

5. The handheld controller according to claim 4 wherein the processor is operable to receive images acquired by the camera and to process the images to determine measures of changes in position and/or orientation of the handheld controller.

6. The handheld controller according to claim 5 wherein the processor is operable to process the images to determine optic flow evidenced by the images.

7. The handheld controller according to claim 6 wherein the processor is operable to use the determined optic flow to correct the dead reckoning positions and/or orientations for drift.

8. The handheld controller according to claim 1 wherein the processor repeatedly updates and transmits the P/O data to the computer.

9. The handheld controller according to claim 8 wherein when the actuator is operated to disengage the P/O data, the processor does not update the P/O data.

10. The handheld controller according to claim 9 wherein as long as the P/O data is disengaged, the processor repeatedly transmits to the computer P/O data that was last updated prior to disengagement of the P/O data.

11. The handheld controller according to claim 9 wherein as long as the P/O data is disengaged, the processor abstains from transmitting P/O data to the computer.

12. The handheld controller according to claim 1 wherein the actuator is operable to engage the P/O data if the P/O data is disengaged.

13. The handheld controller according to claim 1 wherein the handheld controller is operable to interface a user with a virtual environment of a computer game.

14. The handheld controller according to claim 1 wherein the apparatus configured to generate the measurements and the processor are comprised in a smartphone mounted to a cradle comprising the projector.

15. A method of interfacing a user with a computer generated environment, the method comprising:
receiving streaming video data that defines video images of a computer environment generated by a computer;
projecting images defined by the video data in a direction of a projection axis to form the images on a surface that the projection axis intersects so that a user may view and interact with the images;
transmitting P/O data that defines position and/or orientation of the projection axis substantially in real time to control regions of the computer environment for which the computer streams video data for projection; and
pausing updating the P/O data to enable the direction of the projection axis to be changed without changing a region for which the streaming video is received.

16. The method according to claim 15 wherein transmitting P/O data comprises acquiring data provided by an inertial measurement unit (IMU) and processing the IMU data to determine dead reckoning positions and/or orientations of the projection axis.

17. The method according to claim 16 wherein transmitting P/O data comprises:
acquiring images of scenes in a real physical environment of the projection axis;
processing data in the images to determine optic flow generated by movement of the projection axis; and
using the optic flow to correct the dead reckoning position and/or controlling for drift.

18. The method according to claim 15 and subsequent to pausing, comprising transmitting P/O data that was last updated prior to pausing to the computer.

19. The method according to claim 15 and comprising using a smartphone to provide and transmit the P/O data and receive the streaming video data.

20. The method according to claim 15 wherein the computer environment comprises a video game virtual environment.
